(19) United States
(12) Patent Application Publication
(10) Pub. No.: US 2019/0158384 A1
(43) Pub. Date: May 23, 2019

(54) Efficient Operand Multicast For Acceleration

(71) Applicant: NVXL Technology, Inc., Fremont, CA (US)

(72) Inventors: Bharadwaj Pudipeddi, San Jose, CA (US); Federico Sambilay, Fremont, CA (US); Richard A. Cantong, Fremont, CA (US)

(21) Appl. No.: 16/017,961

(22) Filed: Jun. 25, 2018

Related U.S. Application Data
(60) Provisional application No. 62/524,429, filed on Jun. 23, 2017.

(51) Int. Cl. H04L 12/707; G06F 17/16; H04L 29/08; H04L 12/761; H04L 12/803; G06N 3/08; G06N 3/04

(52) U.S. Cl. CPC H04L 45/24; G06F 17/16; H04L 67/1004; G06N 20/00; H04L 47/125; G06N 3/08; G06N 3/0454; H04L 45/16

(57) ABSTRACT

In an embodiment of the invention, an apparatus comprises: a requestor configured to transmit a first operand and a second operand, wherein the first operand is partitioned; a shared network configured to transmit the operands; a processing load balancer for receiving the operands; a plurality of processing elements that are configured to process the operands; and a private network configured to multicast the operands to the processing elements. In another embodiment of the invention, a method comprises: transmitting a first operand and a second operand from a requestor, wherein the first operand is partitioned; transmitting the operands along a shared network; receiving the operands by a processing load balancer; multicasting the operands by a private network; and processing the operands by a plurality of processing elements. In yet another embodiment of the invention, an article of manufacture comprises a non-transitory computer-readable medium having stored thereon instructions operable to permit an apparatus to perform a method comprising: transmitting a first operand and a second operand from a requestor, wherein the first operand is partitioned; transmitting the operands along a shared network; receiving the operands by a processing load balancer; multicasting the operands by a private network; and processing the operands by a plurality of processing elements.

### CROSS-REFERENCE(S) TO RELATED APPLICATION

This application claims the benefit of and priority to U.S. Provisional Application No. 62/524,429 which was filed on Jun. 23, 2017. This U.S. Provisional Application No. 62/524,429 is hereby fully incorporated herein by reference.

### FIELD

Embodiments of the invention relate generally the field of computation acceleration in particular for machine learning and deep learning which is often constrained by data bandwidth.

### DESCRIPTION OF RELATED ART

The background description provided herein is for the purpose of generally presenting the context of the disclosure of the invention. Work of the presently named inventors, to the extent the work is described in this background section, as well as aspects of the description that may not otherwise qualify as prior art at the time of filing, are neither expressly nor impliedly admitted as prior art against this present disclosure of the invention.

Machine learning, deep learning, transcoding, and data processing are some workloads that require high network and memory bandwidth when parallelizing across an array of processing engines. For example, a square matrix multiplication of two matrices A and B, with each matrix of dimension n x n where n is an integer value, requires the transmission of three matrices (the two operands and one result matrix C) costing O (3n²). If the matrix A were to be partitioned as k matrices of dimension n/k×n, then the computation can be parallelized across k processing engines. However, the matrix B would now have to be broadcast across all k elements. The transmission bandwidth required would be O (2n²+kn²).

This additional cost on the transmission bandwidth as a polynomial of k often saturates the network especially when the network is either shared with other traffic or the network is pre-existing with limited bandwidth or both.

FIG. 1a is a block diagram that illustrates a parallelized matrix multiplication where one operand (matrix A) is partitioned. For example, the matrix A is partitioned to partitioned matrices A1, A2, through Ak.

Matrix A1 comprises a11, a12, . . . , a1n through ak1, ak2, . . . , akn.

Matrix Ak comprises a (n−k+1)1, . . . , a (n−k+1)n, through an1, an2, . . . , ann.

Matrix B comprises b11, b12, . . . , b1n, through b21, b22, . . . , b2n, through bn1, bn2, . . . , bnn.

Matrix C comprises partitioned matrices C1, C2, through Ck, wherein C1=A1×B, C2=A2×b, through Ck=Ak×B. The matrices C1, C2, . . . , Ck can be concatenated so as to form the matrix C from the matrices C1, C2, . . . , Ck.

Matrix C1 comprises c11, c12, . . . , c1n, through ck1, ck2, . . . , ckn.

The number of partitioned matrices C1, C2, . . . , Ck and the number of partitioned matrices A1, A2, . . . , Ak may vary as symbolically shown by the dot symbols 105.

A second example is data and model parallelism in neural networks where either model parameters are sent over a network to multiple processing elements (for instance in synchronous stochastic gradient descent in training) or the same data is sent over to different models (for instance, again in training of various neural networks). For example, FIG. 1b is a block diagram of a method of transmission where the other operand (B) is multicast to multiple processing elements (e.g., PE1, PE2, . . . , through PEk) via a network from a requestor (caller). The number of processing elements PE1, PE2, . . . , PEk may vary as symbolically shown by the dot symbols 150.

In FIG. 1b, the two matrices A and B are multiplied such that transmission via a network occur for matrices {A1, B}, {A2, B}, . . . {Ak, B} with matrix A being partitioned prior to the square matrix multiplication of the two matrices A and B. Processing elements 152 (e.g., processing elements PE1, PE2, . . . , PEk) receive matrices {A1, B}, {A2, B}, . . . , {Ak, B}, respectively, via the network 154.

Any of the processing elements 152 can be, for example, an accelerator which can be implemented by, for example, a field programmable gate array (FPGA), a server, a computing engine, or another type of processing device. The requestor (caller) or client 155 can be, for example, a central processing unit (CPU) or a server, or another type of host. The network 154 can be, for example, a PCIe (Peripheral Component Interface Express) topology.

In the conventional approach that is shown in FIG. 1b the matrix B is transmitted four (4) times along the network 154 to the processing elements (PE1, PE2, . . . , PEk). For example, matrix B has the size of 1024×1024 pixels. The matrix A is partitioned into k matrices. For example, the matrix A is partitioned into four matrices (A1, A2, . . . Ak) with each of the four matrices having the size of 1024×256 pixels. The matrix A is partitioned on the host side (e.g., by the requestor or caller 155) by a suitable method such as, for example, data striping. By partitioning the matrix A, the tasks for processing the two matrices A and B is divided across the multiple processing elements PE1, PE2, . . . , PEk.

As an example, matrices A1, A2, . . . , Ak can form an image or user data or a filter. An image can be for example, a picture. A filter comprises filter weights. If matrices A1, A2, . . . , Ak form an image or user data, then matrix B forms a filter. If matrices A1, A2, . . . , Ak form a filter, then matrix B forms an image or user data.

A third example involves transcoding. If an image or/and video needs to be transcoded into multiple formats by different processing engines (i.e., processing elements), the same input must be sent to multiple processing elements where each processing engine is configured to transcode to a different format. This is normally done by having to broadcast the same image or/and video to every processing engine.

FIG. 2 is a block diagram showing an example transcoding replication, wherein a video 222 or an image 222 is processed simultaneously for multiple formats. As shown in FIG. 2, the requestor (caller) 220 sends an image 222 or/and video 222 (e.g., as best represented by block symbols 1, . . . , k to the network 225 and the same image 222 or/and same video 222 is sent to each of the multiple processing engines (processing elements) PE1, PE2, . . . , PEk which form the transcoders 230. Each processing engine is configured to transcode the image 222 or/and video 222 to a different format. For example, the processing engine PE1 transcodes the video 222 into the MPEG4 format, the processing engine PE2 transcodes the video 222 into the H.264 format, and the processing engine PEk transcodes the video 222 into another format. The number of transcoders 230 may vary as symbolically shown by the dot symbols 232. The transcoded images 222 or/and video 222 are then transmitted to a destination 240.

As an example, the requestor (caller 220) can be a host device or a CPU.

As an example, the network 225 can be a PCIe topology, a wireless network, a radio communication network, a cloud network, or another type of communication network 225.

As an example, any or all of the processing engines PE1, PE2, . . . , PEk can be a server, an FPGA device, a computing engine, or another type of processing device. As another example, the processing engines PE1, PE2, . . . , PEk can be servers that are connected via a network switch to the network 225. As another example, the processing engines PE1, PE2, . . . , PEk can be PCIe connected devices via the network 225.

The communication path (or communication paths) 235 between the processing engines PE1, PE2, . . . , PEk can be any type of communication paths that allow communications to occur between the processing engines PE1, PE2, . . . , PEk and the destination 240.

As an example, the destination 240 can be a network that further transmits the transcoded images 222 or/and transcoded videos 222 to a further destination (e.g., a device, a cloud storage, another network, or another destination), at least one storage device for storing the transcoded images 222 or/and transcoded videos 222, or at least one server for performing an additional processing on the transcoded images 222 or/and transcoded videos 222.

While the above discussed conventional approaches are suited for their intended purposes, theses conventional approaches can still be subjected to potential network bottleneck problems.

There is a continuing need to overcome the constraints and/or disadvantages of conventional approaches.

### SUMMARY

Embodiments of the invention relate generally the field of computation acceleration in particular for machine learning and deep learning which is often constrained by data bandwidth.

In an embodiment of the invention, an apparatus comprises: a requestor configured to transmit a first operand and a second operand, wherein the first operand is partitioned; a shared network configured to transmit the operands; a processing load balancer for receiving the operands; a plurality of processing elements that are configured to process the operands; and a private network configured to multicast the operands to the processing elements.

In another embodiment of the invention, a method comprises: transmitting a first operand and a second operand from a requestor, wherein the first operand is partitioned; transmitting the operands along a shared network; receiving the operands by a processing load balancer; multicasting the operands by a private network; and processing the operands by a plurality of processing elements.

In yet another embodiment of the invention, an article of manufacture comprises a non-transitory computer-readable medium having stored thereon instructions operable to permit an apparatus to perform a method comprising: transmitting a first operand and a second operand from a requestor, wherein the first operand is partitioned; transmitting the operands along a shared network; receiving the operands by a processing load balancer; multicasting the operands by a private network; and processing the operands by a plurality of processing elements.

It is to be understood that both the foregoing general description and the following detailed description are exemplary and explanatory only and are not restrictive of the invention, as claimed. For example, the foregoing general description presents a simplified summary in order to provide a basic understanding of some aspects described herein. This summary is not an extensive overview of the claimed subject matter. This summary is intended to neither identify key or critical elements of the claimed subject matter nor delineate the scope thereof. The sole purpose of the summary is to present some concepts in a simplified form as a prelude to the more detailed description that is presented later.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

It is to be noted, however, that the appended drawings illustrate only typical embodiments of this invention and are therefore not to be considered limiting of its scope, for the present invention may admit to other equally effective embodiments.

FIG. 1a is a block diagram that illustrates parallelized matrix multiplication where one operand is partitioned.

FIG. 1b is a block diagram of a method of transmission where the other operand (B) is multicast to several processing elements (PEs).

FIG. 2 is a block diagram that illustrates a transcoding replication, where a video is processed simultaneously for multiple formats.

FIG. 3 is a block diagram of a multicast solution with a PLB and private network, in accordance with an embodiment of the invention.

FIG. 4 is a flow diagram of a method, in accordance with an embodiment of the invention.

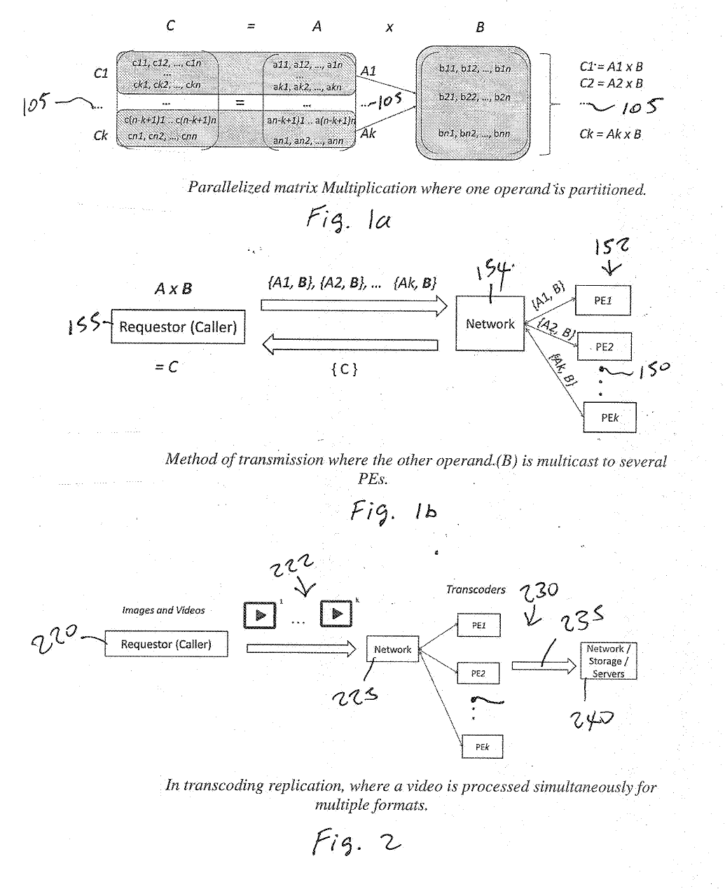

### DETAILED DESCRIPTION

In the following detailed description, for purposes of explanation, numerous specific details are set forth to provide a thorough understanding of the various embodiments of the present invention. Those of ordinary skill in the art will realize that these various embodiments of the present invention are illustrative only and are not intended to be limiting in any way. Other embodiments of the present invention will readily suggest themselves to such skilled persons having the benefit of this disclosure.

In addition, for clarity purposes, not all of the routine features of the embodiments described herein are shown or described. One of ordinary skill in the art would readily appreciate that in the development of any such actual implementation, numerous implementation-specific decisions may be required to achieve specific design objectives. These design objectives will vary from one implementation to another and from one developer to another. Moreover, it will be appreciated that such a development effort might be complex and time-consuming, but would nevertheless be a routine engineering undertaking for those of ordinary skill in the art having the benefit of this disclosure. The various embodiments disclosed herein are not intended to limit the scope and spirit of the herein disclosure.

Exemplary embodiments for carrying out the principles of the present invention are described herein with reference to the drawings. However, the present invention is not limited to the specifically described and illustrated embodiments. A person skilled in the art will appreciate that many other embodiments are possible without deviating from the basic concept of the invention. Therefore, the principles of the present invention extend to any work that falls within the scope of the appended claims.

As used herein, the terms “a” and “an” herein do not denote a limitation of quantity, but rather denote the presence of at least one of the referenced items.

In the following description and in the claims, the terms “include” and “comprise” are used in an open-ended fashion, and thus should be interpreted to mean “include, but not limited to . . . ”. Also, the term “couple” (or “coupled”) is intended to mean either an indirect or direct electrical connection (or an indirect or direct optical connection). Accordingly, if one device is coupled to another device, then that connection may be through a direct electrical (or optical) connection, or through an indirect electrical (or optical) connection via other devices and/or other connections.

A fundamental idea in an embodiment of this invention is to eliminate the additional cost of transmission across a shared network and move that responsibility to a private network (P-NW) specifically used for clustering the processing elements. To make the network highly efficient in transmission, the processing elements (PEs) are clustered together with a separate private network (P-NW) that is capable of multicasting either through software, firmware, or direct hardware support. In the system 300, the requestor (or caller) 302 or client 302 can control the multicasting at a software level. Alternatively, the receiver on the networking side would be configured to do that multicasting itself (such as the transcoding example where the image or video is simply replicated to all nodes or to all processing elements).

By adding an additional segment into the network for internal broadcast, the bandwidth requirement on the shared network is only proportional to the number of operands but not the number of processing engines. Also, the additional segment can be a high-speed, multi-cast non-blocking network with low overhead such as a PCIe switch. To make this work, in the network 300, there are one or more receivers called PLB (processing load balancers) 305 which can be either a dedicated functionality or dual-function (networking and processing elements too). The PLB 305 receives the operands via the network 315.

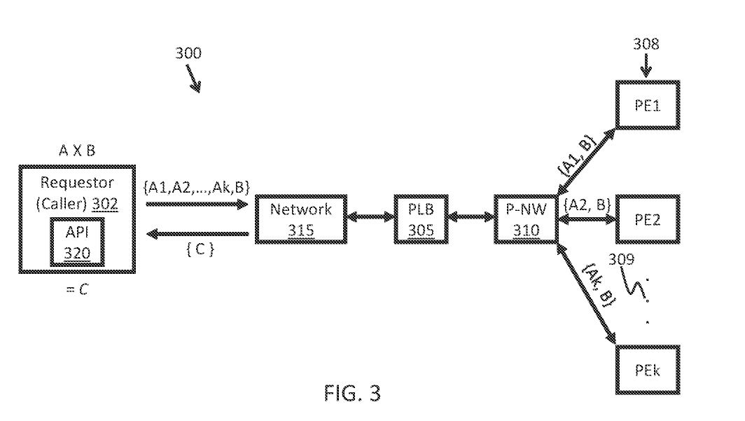

FIG. 3 is a block diagram that illustrates an embodiment of the solution in a system 300 where there is one dedicated PLB 305. FIG. 3 shows an embodiment of a multicast solution with a PLB 305 and private network (P-NW) 310. In practice, there are typically multiple PLBs 305 and the PLBs 305 may as well be PEs (processing elements) too. In other words, the multiple PLBs 305 can perform the functions and operations of the PEs 308 in another embodiment of the invention. The PLBs 305 and PEs 308 are connected by a topological switch or switches. In FIG. 3, this topological switch is represented by a private network (P-NW) 310. For instance, P-NW 310 could be a PCIe switch or switches supporting up to approximately 64 devices. In FIG. 3, the PEs 308 are shown as PE1, PE2, . . . , PEk. The number of PEs 308 in FIG. 3 may vary as shown by the dot symbols 309.

Any of the PEs 308 can be, for example, an accelerator which can be implemented by, for example, a field programmable gate array (FPGA), a server, a computing engine, or another type of processing device.

The requestor (caller) or client 302 can be, for example, a central processing unit (CPU) or a server, or another type of host.

FIG. 3 also shows the impact of doing parallel matrix multiplication over the network. Only one instance of the operand B needs to be sent over the shared network 315, while the other operand A is partitioned. Note that this example is a B-multicast example and A-partitioned in FIG. 3 (i.e., {A1, A2, . . . Ak, B}). However, the example of FIG. 3 could very well be A-multicast and B-partitioned as well (i.e., {B1, B2, . . . , Bk, A}). The PLB 305 upon receiving {A1, A2, . . . Ak, B} will multicasts {A1, A2, . . . , Ak, B} over the private network 310 to the processing engines 308 and thereby save potentially a tremendous amount of network latency and congestion.

The matrices A, B, and C have been similarly discussed above. A matrix (e.g., matrix A), can be partitioned by, for example, data striping.

In this example of FIG. 3, the requestor 302 now conveys the operands A and B to the PLB 305 to replicate matrix B across all Processing Elements 308 (PE1, PE2, . . . , PEk) through a multicast address set when transferring matrix B. In other words, the PLB 305 will multicast the matrix B to each of the processing elements PE1, PE2, . . . PEk by use of P-NW 310. The requestor 302 may also include a special API (application program interface) 320 to replicate matrix B. In fact, the PLB 305 itself may determine the set of PEs 308 that need to receive matrix B and multicast itself. The multicasting can be done by multiple unicasting from the PLB 305 or through hardware support from the switch or switches. Therefore, an embodiment of his invention demonstrates an intelligent networking solution capable of low latency and high network efficiency.

As an example, the PLB 305 can be a server that performs load balancing.

As an example, the private network (P-NW) 310 can be a PCIe switch.

The network 315 can be, for example, a PCIe topology, a wireless network, a radio communication network, a cloud network, or another type of communication network 315.

Network bandwidth is saved since matrix B is only sent once and sent to every destination comprising the processing elements PE1, PE2, . . . , PEk. By saving network bandwidth, the network 315 can be efficiently used by other computers in the server room for network transmission. In other words, since the network 315 is typically shared with other traffic or the network 315 may be pre-existing with limited bandwidth or both, by adding the PLB 305 and P-NW 310 into the network 300 for internal broadcast, the bandwidth required on the shared network 225 is only proportional to the number of operands but not to the number of processing engines 308. By sending matrix B only once along the network 315 and by not repeatedly sending matrix B along the network 315, the transmission bottleneck problems of conventional systems is also avoided by an embodiment of the invention since the network 315 can be available for transmission from other computers.

In FIG. 3, the processing engines PE1, PE2, . . . , PEk receives the matrices {A1, B}, {A2, B}, . . . , {A1=k, B}, respectively.

The processing elements (processing engines) PE1, PE2, . . . , PEk can be accelerators for performing acceleration, transcoders for performing transcoding, and/or processing engines for performing other processing operations. For example, the processing elements PE1, PE2, . . . , PEk accelerate the matrices {A1, B}, {A2, B}, . . . , {Ak, B}, respectively. As another example, the processing elements PE1, PE2, . . . , PEk transcode the matrices {A1, B}, {A2, B}, . . . , {Ak, B}, respectively.

In another embodiment of the invention, the processing engines 308 can perform peer to peer transmissions to permit further savings in bandwidth. For example, the processing engine PE1 receives matrices {A1, B}, {A2, B}, . . . , {Ak, B} but processes the matrix {A1, B} and the processing engine PE1 transmits the matrices {A2, B}, . . . , {Ak, B} to the processing engine PE2; the processing engine PE2 processes the matrix {A2, B} and the processing engine PE2 transmits the matrix {Ak, B} to the processing engine PEk; the processing engine PEk then processes the matrix {Ak, B}.

Note that the processing engines PE1, PE2, . . . , PEk can transmit the processed content or processed data (matrices) {A1, B}, {A2, B}, . . . , {Ak, B} via a communication path (e.g., similar to the communication path 235 in FIG. 2) to a destination (e.g., similar to the destination 240). Therefore, a destination of the matrices {A1, B}, {A2, B}, . . . , {Ak, B} can stored further process, or further transmit the matrices {A1, B}, {A2, B}, . . . , {Ak, B}. At least one of the matrices {A1, B}, {A2, B}, . . . , {Ak, B} can be transmitted to a destination such as another network, a storage, or a server.

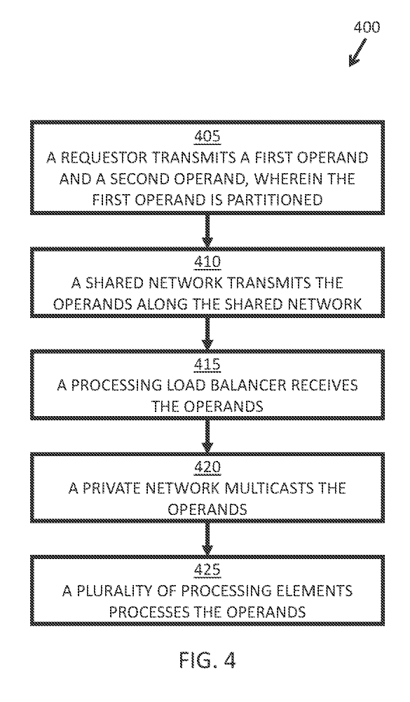

FIG. 4 is a flow diagram of a method 400, in accordance with an embodiment of the invention.

At 405, a requestor (or caller or host) transmits a first operand and a second operand, wherein the first operand is partitioned,

At 410, a shared network transmits the operands along the shared network.

At 415, a processing load balancer receives the operands.

At 420, a private network multicasts the operands.

At 425, a plurality of processing elements processes the operands.

The word “exemplary” (or “example”) is used herein to mean serving as an example, instance, or illustration. Any aspect or embodiment or design described herein as “exemplary” or “example” is not necessarily to be construed as preferred or advantageous over other aspects or embodiments or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity and/or for purposes of focusing on the details of the subject innovation.

As used in herein, the terms “component”, “system”, “module”, “element”, and/or the like are intended to refer to a computer-related entity, either hardware, a combination of hardware and software, software, or software in execution. For example, a component or element may be, but is not limited to being, a process running on a processor, a processor, an object, an instance, an executable, a thread of execution, a program, and/or a computer. By way of example, both an application running on a computer and the computer can be a component. One or more components may reside within a process and/or thread of execution and a component may be localized on one computer and/or distributed between two or more computers.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless.

It is also within the scope of the present invention to implement a program or code that can be stored in a non-transient machine-readable medium (or non-transitory machine-readable medium or non-transient computer-readable medium or non-transitory computer-readable medium) having stored thereon instructions that permit a method (or that permit a computer) to perform any of the inventive techniques described above, or a program or code that can be stored in an article of manufacture that includes a non-transient computer readable medium (non-transitory computer readable medium) on which computer-readable instructions for carrying out embodiments of the inventive techniques are stored. Other variations and modifications of the above-described embodiments and methods are possible in light of the teaching discussed herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A system, comprising:
a requestor configured to transmit a first operand and a second operand, wherein the first operand is partitioned;
a shared network configured to transmit the operands;
a processing load balancer for receiving the operands;
a plurality of processing elements that are configured to process the operands; and
a private network configured to multicast the operands to the processing elements.

2. The system of claim 1, wherein the first operand comprises matrix A and wherein the matrix A is partitioned into matrix A1 and matrix A2.

3. The system of claim 1, wherein the plurality of processing elements comprises a first processing element and a second processing element and wherein the private network transmits matrix {A1, B} to the first processing element and transmits matrix {A2, B} to the second processing element.

4. The system of claim 2, wherein the first processing element accelerates the matrix {A1, B} and wherein the second processing element accelerates the matrix {A2, B}.

5. The system of claim 2, wherein the first processing element transcodes the matrix {A1, B} and wherein the second processing element transcodes the matrix {A2, B}.

6. The system of claim 2, wherein the first processing element transmits the matrix {A1, B} to a destination.

7. The system of claim 6, wherein the destination comprises another network, a storage, or a server.

8. The system of claim 2 wherein the first processing element is configured to receive the matrices {A1, B} and {A2, B} and wherein the first processing element is configured to transmit the matrix {A2, B} to the second processing element.

9. A method, comprising:
transmitting a first operand and a second operand from a requestor, wherein the first operand is partitioned;
transmitting the operands along a shared network;
receiving the operands by a processing load balancer;
multicasting the operands by a private network; and
processing the operands by a plurality of processing elements.

10. The method of claim 9, wherein the first operand comprises matrix A and wherein the matrix A is partitioned into matrix A1 and matrix A2.

11. The method of claim 9, wherein the plurality of processing elements comprises a first processing element and a second processing element and wherein the private network transmits matrix {A1, B} to the first processing element and transmits matrix {A2, B} to the second processing element.

12. The method of claim 11, wherein the first processing element accelerates the matrix {A1, B} and wherein the second processing element accelerates the matrix {A2, B}.

13. The method of claim 11, wherein the first processing element transcodes the matrix {A1, B} and wherein the second processing element transcodes the matrix {A2, B}.

14. The method of claim 11, wherein the first processing element transmits the matrix {A1, B} to a destination.

15. The method of claim 14, wherein the destination comprises another network, a storage, or a server.

16. The method of claim 11 wherein the first processing element is configured to receive the matrices {A1, B} and {A2, B} and wherein the first processing element is configured to transmit the matrix {A2, B} to the second processing element.

17. An article of manufacture comprising:
a non-transitory computer-readable medium having stored thereon instructions operable to permit an apparatus to perform a method comprising:
transmitting a first operand and a second operand from a requestor, wherein the first operand is partitioned;
transmitting the operands along a shared network;
receiving the operands by a processing load balancer;
multicasting the operands by a private network; and
processing the operands by a plurality of processing elements.

18. The article of manufacture of claim 17, wherein the first operand comprises matrix A and wherein the matrix A is partitioned into matrix A1 and matrix A2.

19. The article of manufacture of claim 17, wherein the plurality of processing elements comprises a first processing element and a second processing element and wherein the private network transmits matrix {A1, B} to the first processing element and transmits matrix {A2, B} to the second processing element.

20. The article of manufacture of claim 19, wherein the first processing element accelerates the matrix {A1, B} and wherein the second processing element accelerates the matrix {A2, B}.

21. The article of manufacture of claim 19, wherein the first processing element transcodes the matrix {A1, B} and wherein the second processing element transcodes the matrix {A2, B}.

22. The article of manufacture of claim 19, wherein the first processing element transmits the matrix {A1, B} to a destination.

23. The article of manufacture of claim 22, wherein the destination comprises another network, a storage, or a server.

24. The article of manufacture of claim 19 wherein the first processing element is configured to receive the matrices {A1, B} and {A2, B} and wherein the first processing element is configured to transmit the matrix {A2, B} to the second processing element.
